(19) United States
(12) Patent Application Publication
(10) Pub. No.: US 2013/0178233 A1
(43) Pub. Date: Jul. 11, 2013

(54) Dynamic Geo-Fence Alerts

(71) Applicants: David C. McCoy, Charlotte, NC (US); John C. Rukavina, Charlotte, NC (US)

(72) Inventors: David C. McCoy, Charlotte, NC (US); John C. Rukavina, Charlotte, NC (US)

(73) Assignee: Bank of America Corporation, Charlotte, NC (US)

(21) Appl. No.: 13/347,158

(22) Filed: Jan. 10, 2012

(51) Int. Cl. H04W 64/00

(52) U.S. Cl. 455/456.3

(57) ABSTRACT

Examples of systems, methods, apparatuses, and software are described in which a mobile device may receive information about a subset of ATMs, VTMs, and/or retail banking locations (and/or other points of interest) based on both the speed and location of the mobile device. The size and/or shape of geo-fences established around each of the subset may also depend upon the speed and/or location of the mobile device. The mobile device may alert the user as to when the mobile device is within one of the speed and/or location-variable geo-fences.

### BACKGROUND

As mobile devices such as cellular phones, global positioning system navigation devices, and tablet computers become more advanced, they are able to increasingly provide highly useful location-aware guidance to users in real time. More recently, a concept known as geo-fencing has been used to determine whether the mobile device is or is not located within a virtual “geo-fence” around a point of interest such as an address, a store, or a home. A geo-fence is a virtual perimeter around a real-world location. Mobile devices that implement geo-fencing functionality may alert the user when the mobile device has entered or exited a predetermined geo-fence.

### SUMMARY

It is believed that the possibilities provided by geo-fencing have not yet been fully realized. This is true especially in the realm of banking, such as by letting the user of a mobile device know when the mobile device is within a geo-fence of a financial transaction location, such as an automated teller machine (ATM), video teller machine or video transaction machine (VTM), or retail banking location, and/or any other point of interest. Because the user may be searching for a financial transaction location by various transportation means (e.g., on foot, by car, on a bicycle, etc.), the user's speed may be a factor in determining the size and/or shape of the geo-fences around the financial transaction locations. Moreover, the user may be looking for a financial transaction location anywhere in the country or even the world. This means that there may be a tremendous number of possible financial transaction locations to choose from, and it may not be feasible to download the entire database of such financial transaction locations to be locally used by the mobile device. Moreover, it may not be feasible for a server to continuously monitor the mobile device status as to whether a geo-fence has been entered. Therefore, it may be desirable to download only a subset of the database, where the subset may depend upon the location of the mobile device as well as the speed of the mobile device. The speed may be relevant because a user on foot may not be interested in financial transaction locations as far away as a user in a faster vehicle.

Accordingly, some aspects as described herein are directed to, for example, an apparatus comprising a processor and a non-transitory computer-readable medium storing computer-executable instructions and data representing a plurality of points of interest and respective geographical locations of each of the points of interest. The processor may be configured by the computer-executable instructions to perform the following: receiving an indication of a location and a speed of a mobile device, determining, based on the indicated location and speed, a subset of the plurality of points of interest, and sending data representing the subset of the plurality of points of interest and the respective geographical locations of the subset to the mobile device.

Further aspects may be directed to, for example, a method comprising determining, by a computer, a location and a speed of a mobile device, and determining, by the computer, based on the determined location and speed, a subset of a predetermined plurality of points of interest, wherein data representing the plurality of points of interest and their respective geographical locations is stored in a non-transitory computer-readable medium. The method may further comprise wirelessly sending data representing the subset of the plurality of points of interest and the respective geographical locations of the subset to the mobile device.

Still further aspects may include, for instance, A mobile device comprising a processor and a non-transitory computer-readable medium storing computer-executable instructions and data representing a plurality of points of interest and respective geographical locations of each of the points of interest. The processor may be configured by the computer-executable instructions to perform any or all of the following: determining a first speed of the mobile device at a first time, determining a plurality of geo-fences each containing one of the geographical locations, wherein a size of each of the geo-fences depends upon the determined first speed of the mobile device, determining whether the mobile device is within one of the geo-fences, and providing an alert to a user of the mobile device responsive to determining that the mobile device is within one of the geo-fences.

Yet further aspects as described herein may include, for example, a method, comprising determining a subset of a plurality of points of interest and respective geographical locations of each of the subset of the points of interest, and determining, by a mobile computing device, whether the mobile computing device is located within a boundary around one of the subset of the points of interest, wherein the boundary depends upon a speed of the mobile computing device. The method may further comprise displaying, by a display of the mobile computing device, a message responsive to determining that the mobile computing device is located within the boundary.

These and other aspects of the disclosure will be apparent upon consideration of the following detailed description.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a block diagram of an example system, in accordance with one or more aspects as described herein;

FIG. 2 is a block diagram of an example computing device, in accordance with one or more aspects as described herein;

FIG. 3 is a representation of example locations of various ATMs or other points of interest and their geo-fences relative to the location of a mobile device, in accordance with one or more aspects as described herein;

FIG. 4 is another representation of example locations of various ATMs or other points of interest and their geo-fences relative to the location of a mobile device, in accordance with one or more aspects as described herein;

FIG. 5 is a flow chart showing example steps that may be performed, in accordance with one or more aspects as described herein;

FIG. 6 is an example screenshot of a user interface that may be presented by a mobile device, in accordance with one or more aspects as described herein;

FIG. 7 is another example screenshot of a user interface that may be presented by a mobile device, in accordance with one or more aspects as described herein;

FIG. 8 is yet another example screenshot of a user interface that may be presented by a mobile device, in accordance with one or more aspects as described herein;

FIG. 9 is another representation of example locations of various ATMs or other points of interest and their geo-fences relative to the location of a mobile device, in accordance with one or more aspects as described herein; and

FIG. 10 is an example screenshot of a notification that may be presented by a mobile device, in accordance with one or more aspects as described herein.

### DETAILED DESCRIPTION

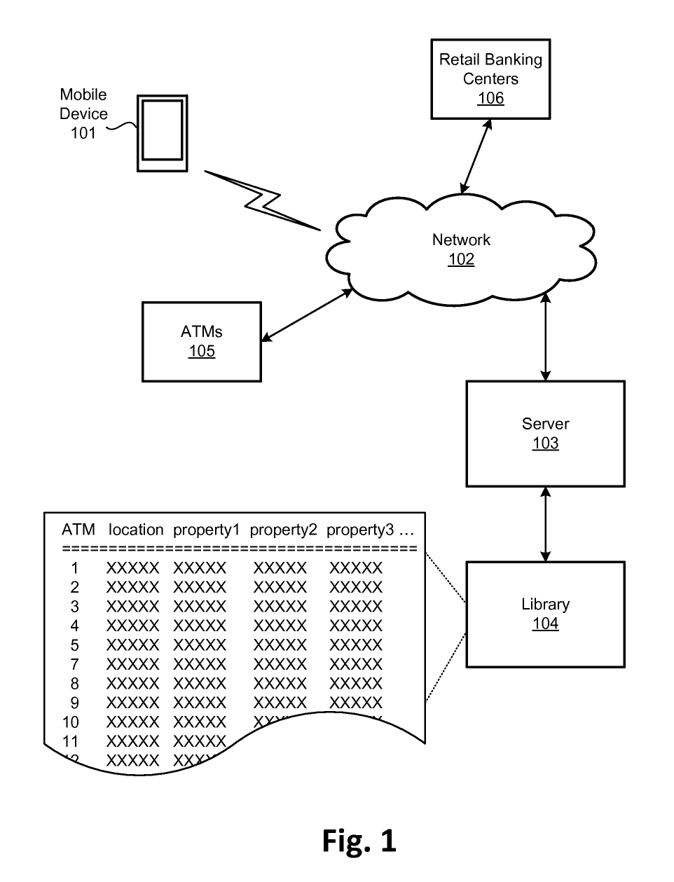

FIG. 1 is a block diagram of an example system that may be used to implement one or more of the features and functions as described herein. In this example, the system may include one or more mobile devices (e.g., mobile device 101); one or more automated teller machines (ATMs) 105, video teller machines or video transaction machines (VTMs), retail banking centers 106, and/or other points of interest; one or more servers (e.g., server 103); one or more data storage facilities (e.g., library 104) for storing data; and/or one or more networks (e.g., network 102) providing for communication between any of the other elements 101, 103, 104, 105, and/or 106.

Mobile device 101 may be any portable computing device with which a user may interact, such as a mobile phone (e.g., a cellular phone and/or a smart phone), a tablet computer, a global positioning system (GPS) mapping device (commonly found in automobiles or available as a handheld device), or a laptop computer. Mobile device 101 may send and/or receive data to and/or from other devices and systems, such as via network 102. While only a single mobile device 101 is explicitly shown in FIG. 1, the system may be expected to include a large number of mobile devices. For instance, any mobile device having access to network 102 may be able to be a mobile device operating in accordance with the various examples as discussed herein.

Network 102 may include, for instance, a cellular carrier network, a landline telephone network, the Internet, an intranet, a local area network (LAN) a wireless local area network (WLAN), and/or a dedicated connection. For instance, where mobile device 101 is or otherwise includes a cellular telephone, then network 102 may be or otherwise include a cellular carrier network, and so mobile network 101 may directly or indirectly communicate with server 103 via a cellular carrier network.

ATMs 105 and/or retail banking centers 106 may also communicate with other devices, such as server 103, via network 102. For instance, ATMs 105 and/or retail banking centers 106 are often connected to networks via a satellite, cellular, or landline connection. ATMs 105 and/or retail banking centers may be those of a single financial entity, such as a single bank, or they may be ATMs and/or retail banking centers of a number of different financial entities. Various examples herein may refer specifically to ATMs and/or retail banking centers as points of interest, however it will be understood that these examples may also be used with other types of points of interest, including but not limited to VTMs and/or other financial transaction locations.

Server 103 as depicted in FIG. 1 may represent a single device (such as a single computer) or multiple devices (such as multiple computers). Server 103 may be configured to receive messages (e.g., queries) from mobile device 101 and to respond based on those messages and based on content stored in library 104. For instance, mobile device 101 may provide information about its current location, speed, and/or other characteristics of mobile device 101. In response, server 103 may provide information about at least some of the ATMs 105 and/or retail banking centers 106 to mobile device 101, from information extracted from library 104.

Library 104 may include one or more non-transitory and/or tangible computer-readable media, such as one or more magnetic drives, optical drives, tape drives, and/or memories. The one or more computer-readable media of library 104 may store information about ATMs 105 and/or retail banking centers 106, and the information may be organized and accessible such as using a database software application run by server 103. An example of how the content of ATM library 104 is shown in FIG. 1. In this example, each ATM of ATMs 105 (e.g., ATM 1, ATM 2, ATM 3, etc.) may be associated with a location and one or more non-location properties of the respective ATM. The non-location properties may include, for instance, whether the ATM or retail banking center is currently operational (available for conducting financial transactions), scheduled hours of availability of the ATM or retail banking center, whether the ATM is a 24-hour ATM, whether the ATM or retail banking center is or includes a drive-up ATM or transaction window, whether the ATM or retail banking center is open Sunday, whether the ATM is within a building or outside a building, and/or functional capabilities of the ATM (e.g., talking ATM, braille ATM, video assistance (VTM) capable, having an optical deposited check reader, etc.). Similarly, each retail banking center may be associated with its location and/or its properties, such as whether the retail banking center is currently open for business, scheduled business hours of the retail banking center, and/or whether the retail banking center includes a drive-up window. The location of each ATM and/or retail banking center may be in any format desired, such as latitude/longitude and/or street address. As will be discussed further below, server 103 may use the information stored by library 104 to determine a subset of the ATMs and/or retail banking centers (and their corresponding locations and/or properties) to be sent to mobile device 101, based on the current location, speed, and/or direction of travel of mobile device 101.

Mobile device 101 may interact with server 103 in any of a variety of ways. For example, server 103 may include web server functionality, and mobile device 101 may use an Internet browser software application to interact with server 103 via a web page hosted by the web server. Or, mobile device 101 may utilize a specialized software program dedicated to interacting with server 103.

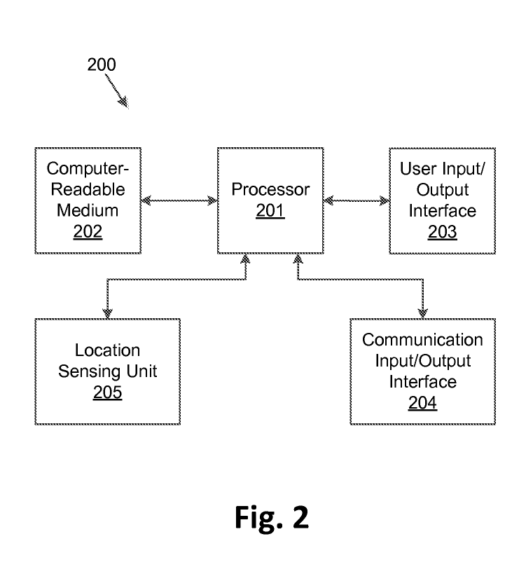

FIG. 2 is a block diagram of an example computing device 200 that may be used to partially or fully embody any or all of the elements 101-106 of FIG. 1. Computing device 200 may include hardware that may execute software to perform specific functions. The software, if any, may be stored on a tangible and/or non-transitory computer-readable medium 202 in the form of computer-readable instructions. Computing device 200 may read those computer-readable instructions, and in response perform various steps as defined by those computer-readable instructions. Thus, any functions, steps, calculations, devices, and other elements described herein may be may be implemented by a computer, such as by reading and executing computer-readable instructions for performing those functions, and/or by any hardware subsystem (e.g., a processor 201, such as a central processing unit, and/or other circuitry) from which computing device 200 is composed. Additionally or alternatively, any of the above-mentioned functions may be implemented by the hardware of computing device 200, with or without the execution of software. For example, computing device 200 may be or include one or more microprocessors, central processing units (CPUs), and/or other types of circuitry configured to perform some or all of the functions attributed to computing device 200. In such embodiments, processor 201 may be implemented as or otherwise include the one or more microprocessors, CPUs, ASICs, and/or other types of circuitry.

A computing device may include any electronic, electro-optical, and/or mechanical device, or system of multiple physically separate or integrated such devices, that is able to process and manipulate information, such as in the form of data. Non-limiting examples of a computing device include one or more personal computers (e.g., desktop, tablet, or laptop), mainframes, servers, cellular phones (which may be “smart phones”), personal digital assistants, global positioning system (GPS) mapping devices, and/or a system of these in any combination or sub-combination. In addition, a given computing device may be physically located completely in one location or may be distributed amongst a plurality of locations (i.e., may implement distributive computing). A computing device may be or include a general-purpose computing device and/or a dedicated computing device configured to perform only certain limited functions.

Computer-readable medium 202 may include not only a single physical non-transitory medium or single type of such medium, but also a combination of one or more such media and/or types of such media. Examples of embodiments of computer-readable medium 202 include, but are not limited to, one or more memories, hard drives, optical discs (such as CDs or DVDs), magnetic discs, and magnetic tape drives. Computer-readable medium 202 may be physically part of, or otherwise accessible by, computing device 200, and may store computer-readable instructions (e.g., software) and/or computer-readable data (i.e., information that may or may not be executable).

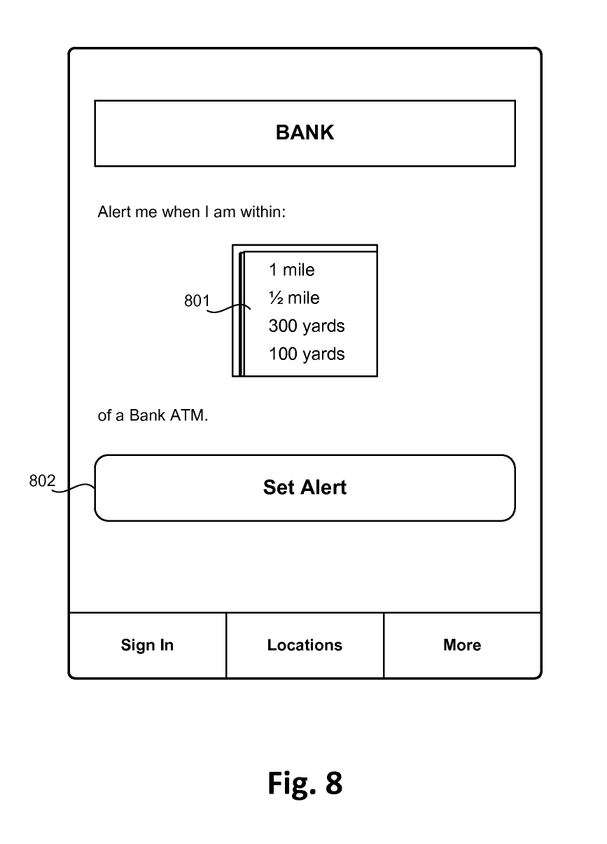

Computing device 200 may also include a user input/output interface 203 for receiving input from a user (e.g., via a keyboard, mouse, touch screen, an audio microphone, camera, and/or remote control) and providing output to the user (e.g., via a touch screen or other display device, an audio speaker or piezoelectric element, and/or a printer). Thus, computing device 200 may cause various user interfaces, such as shown in FIGS. 8-11, to be displayed by such a display device and/or printer, and/or the information may be stored as data in computer-readable medium 202. Computing device 200 may further include a communication input/output interface 204 for communicating with devices and/or networks external to computing device 200, via wire and/or wirelessly.

Computing device 200 may also include a location sensing unit 205, especially where computing device 200 embodies mobile device 101. Location sensing unit 205 may be any hardware and/or software configured to determine the location of the device containing location sensing unit 205. An example of such a location sensing unit 205 may include a global-positioning system (GPS) receiver and processor. In other examples, location-sensing unit 205 may include software configured to triangulate the location of the device based on the measured timing and/or strength of received cellular signals and/or the received signal strength of known wifi network signals. Each of these example location sensing techniques are known and widely used in modern cellular phones, and thus need not be explained in detail herein.

Geo-fencing is a known concept in which the location of a mobile device is compared with a virtual “fence” surrounding a point of interest. For instance, a fixed geo-fence may be established so as to be a circle centered about a point of interest (or, in the case of three-dimensional geo-fences additionally taking altitude into account, a sphere, hemisphere, or other three-dimensional boundary), with a radius of 100 yards. According to known geo-fencing techniques, the entry or exit of a mobile device into the fixed geo-fence may be detected, and may result some defined action being performed (e.g., an alert being issued to the user of the mobile device). Apple Computer. Inc., for example, provides location-aware software developer libraries in its iOS 4 and 5 operating system that support geo-fencing features. As will be discussed herein, geo-fencing technology may be leveraged to provide many new and useful location-based features to mobile device users, especially where the points of interest are ATMs or retail banking centers. For instance, a mobile device may be able to alert a user when the user is proximate to an ATM or retail banking center, where the determination of proximity may be based on either or both the location and the speed of the mobile device. In such a case, the size and/or shape of the geo-fence around an ATM, retail banking center, or any other desired point of interest may depend upon the speed of the mobile device. Moreover, the mobile device may be provided with only a subset of a total library of ATMs and/or retail banking centers (and/or other points of interest), where the subset may also depend upon both the location and speed of the mobile device, and possibly also may depend upon the direction of travel of the mobile device. Example implementations of these features will be discussed further below.

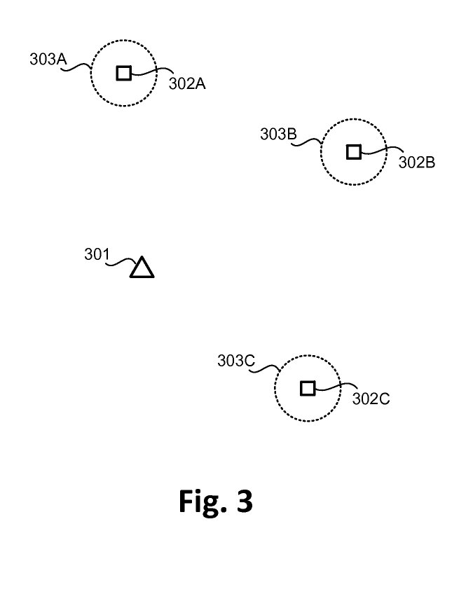

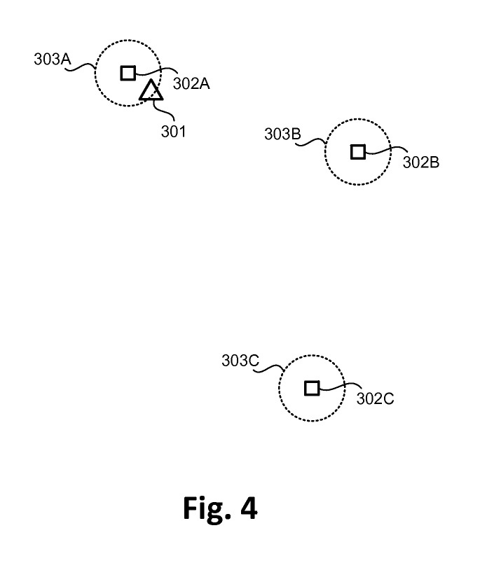

FIG. 3 is a representation of example locations of various ATMs or other point of interest and their geo-fences relative to the location of a mobile device, such as mobile device 101. In this example, the location of mobile device 101 is indicated by location 301, and the locations of three ATMs are indicated by locations 302A, 302B, and 302C (collectively referred to as locations 302). Each of the locations 302 also has a geo-fence 303A, 303B, 303C (collectively referred to as geo-fences 303) enclosing each of the locations 302. In this example, it can be seen that the location 301 of the mobile device is not within any of the geo-fences 303. Next, in the example of FIG. 4, it can be seen that the mobile device has moved into the area defined by geo-fence 303A. Thus, at this point, it may be considered that the mobile device has entered this geo-fence. In these figures, locations 303 may alternatively be locations of retail banking centers and/or any other points of interest as desired.

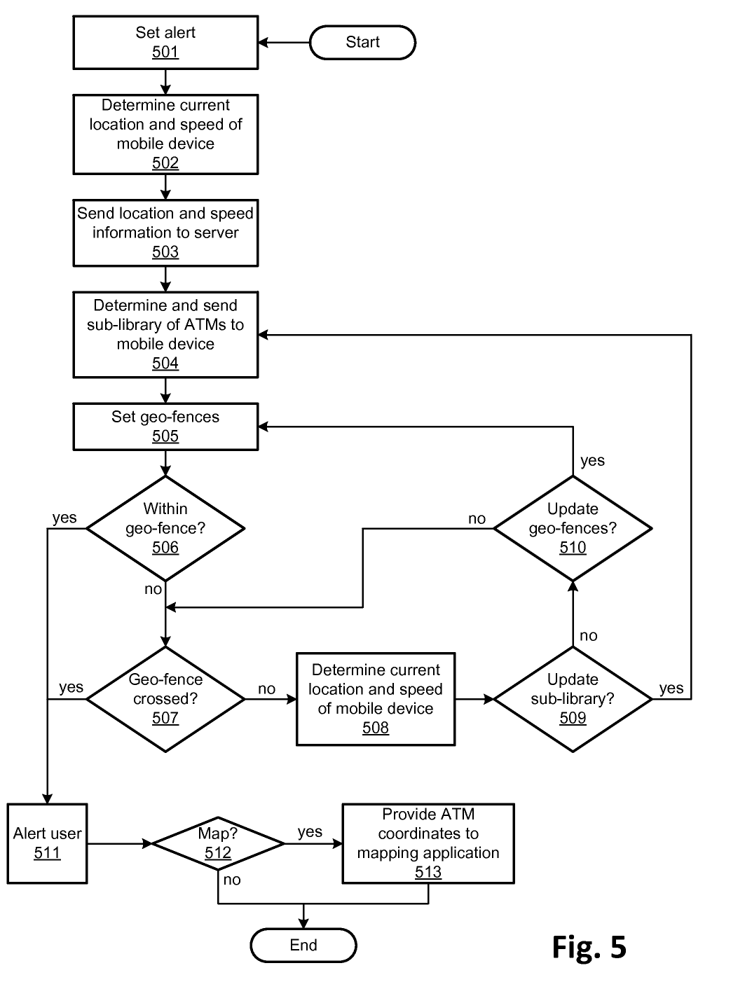

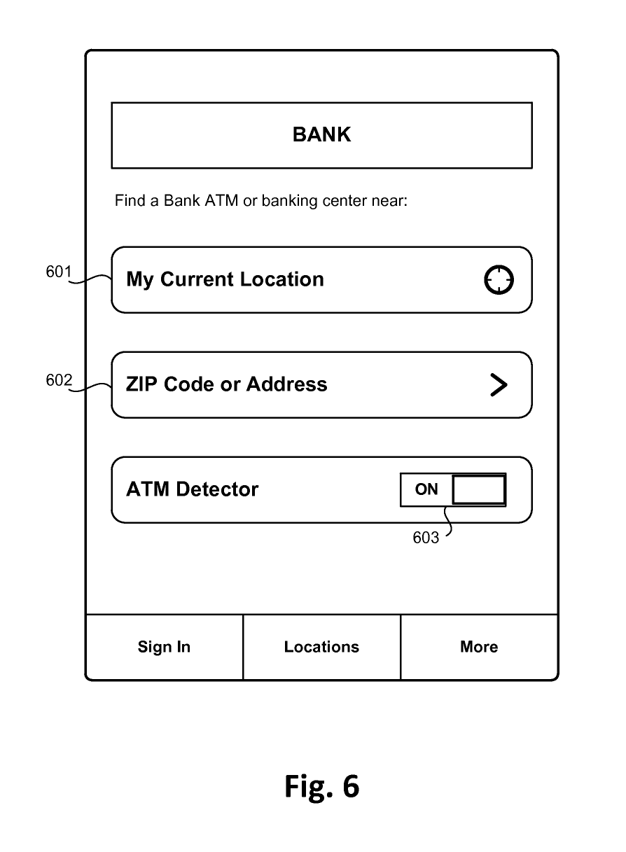

FIG. 5 is a flow chart showing example steps that may be performed during an example operation of the system of FIG. 1. At step 501, an alert condition may be set at mobile device 101, such as via as user interface. For example, as shown in FIG. 6, the user may be presented with a displayed user interface (e.g., displayed on a display of mobile device 101) having a selectable on/off switch 603 for turning on and off the alert function. If the alert function is off, then the remainder of the steps of FIG. 5 may not be performed. If the alert function is on, then the process may proceed to step 502. The user interface may also include one or more other options, such as requesting mobile device 101 to find an ATM or retail banking center closest to the location of mobile device 101 (selectable option 601), or to find an ATM or retail banking center based on an entered zip code and/or address (selectable option 602).

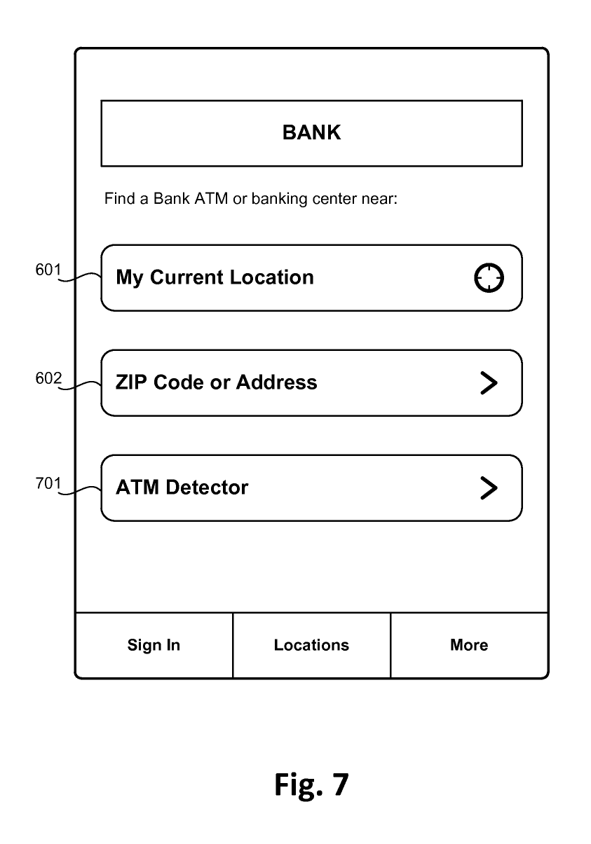

Another example of such a user interface is shown in FIGS. 7 and 8. In FIG. 7, it can be seen that the user interface may alternatively include a selectable ATM Detector button 701. Rather than a simple on/off switch as in the example of FIG. 6, selecting the ATM Detector button may cause the user interface of FIG. 8 to be displayed, which provides the user with additional alert setting options. In the example of FIG. 8, the user may be able to select the size of the geo-fence to be placed around each ATM or retail banking center. For instance, using dial 801, the user may be able to select a radius of the geo-fences to be one mile, one-half mile, three hundred yards, or one hundred yards. Of course, these numbers are merely examples—any values may be used. Once the geo-fence radius is set, the user may select button 802 to set the alert.

In still further example embodiments, the user may set various settings (such as geo-fence radius, ATM criterion, etc.) either within the application itself or using a separate preferences screen or configuration application.

It is noted that, in both the example of FIG. 6 and the example of FIGS. 7 and 8, the application may allow the user to log in to the application, such as to perform secure banking transactions. However, in either example, the user may be able to set the ATM alert function without necessarily needing to log in. This may be desirable because this may allow both bank customers and non-bank customers to take advantage of the ATM alert function.

At step 502, mobile device 101 and/or server 103 may determine the location, speed, and/or direction of travel of mobile device 101 such as using known techniques (e.g., via GPS). At step 503, mobile device 101 may send a message to server 103 indicating the determined location, speed, and/or direction of travel. As discussed previously, the message may be sent to server 103 via network 102.

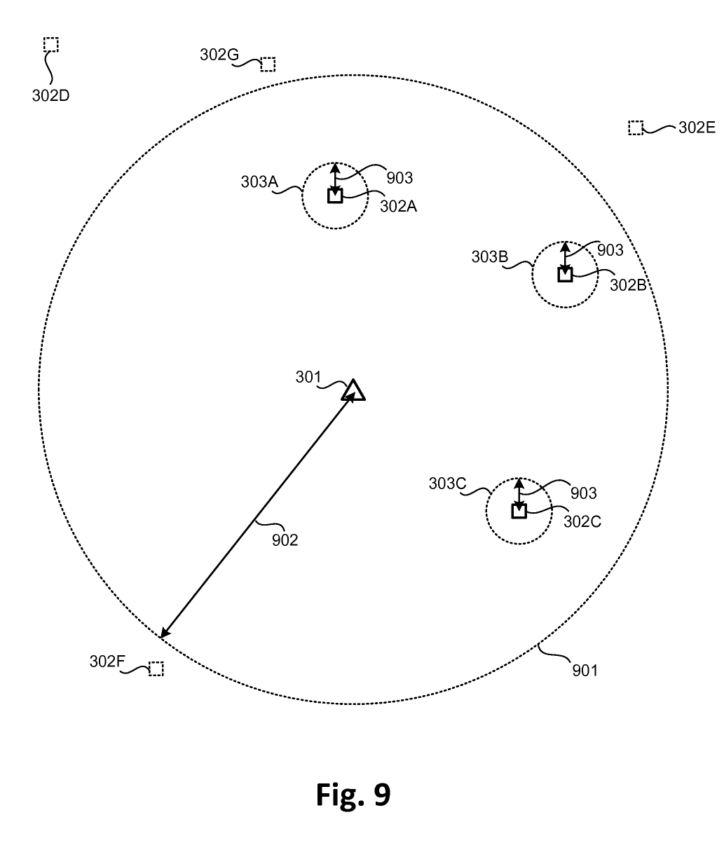

At step 504, server 103 may determine a subset of the ATMs and/or retail banking centers listed in library 104 based on the indicated location, speed, and/or direction of travel information. To determine the subset, a geographical search boundary may be established, in which the size and/or shape of the search boundary may depend upon the indicated location, speed, and/or direction of travel of mobile device 101. For example, referring to FIG. 9, a search boundary 901 is shown relative to the location 301 of mobile device 101 and to the various ATMs that may be listed in library 104. In this example, search boundary 901 is a circle that is centered around the indicated location 301 of mobile device 101 and has a radius 902 that depends upon the indicated speed of mobile device 101. In other embodiments, search boundary 901 may be a shape other than a circle. For instance, search boundary 901 may be any two-dimensional geometric or non-geometric shape such as an oval, polygon, rectangle, square, or triangle, or any three-dimensional geometric or non-geometric shape such as a sphere, ovoid, polygon, box, or pyramid. Moreover, search boundary may have a position (e.g., center, center of mass, etc.) that depends upon the indicated location 301 of mobile device 101, even if the center of search boundary 901 (if any) is not necessarily equal to the indicated location 301 of mobile device 101. For instance, where mobile device 101 is traveling in a particular direction, the center of search boundary 901 may be at a location that is further along a vector of the travel.

As mentioned above, the radius 902 of search boundary 901 in the example of FIG. 9 may depend upon the indicated speed of mobile device 101. More generally speaking, for any given shape of search boundary 901, the area enclosed by search boundary 901 may depend upon the indicated speed of mobile device 101. For instance, the area (and/or radius) may be larger for a higher indicated speed, and smaller for a lower indicated speed. This may be desirable, since it may be expected that a user who is traveling quickly (e.g., via an automobile) is more likely to be interested in ATMs or retail banking centers that are slightly further away that would a user who is traveling more slowly (e.g., by walking)

In still further embodiments, the area enclosed by search boundary 901 may additionally or alternatively depend upon the indicated location of mobile device 101. For instance, if mobile device 101 is located in a highly urban area (e.g., a downtown city location), then the user of mobile device 101 may be less likely to want to travel far due to traffic concerns than would a user located in a less urban area (e.g., the countryside).

In still further embodiments, the area enclosed by search boundary 901 may additionally or alternatively be determined such that at least a predetermined threshold number of ATMs (and/or retail banking centers) are included within the bounds of search boundary 901. Moreover, the predetermined threshold number may depend upon the indicated speed and/or location of mobile device 101. For instance, when mobile device 101 is located in the city, where it may be expected that a relatively high density of ATMs exists, the threshold number may be lower than it would be if mobile device 101 were in a less-ATM-dense countryside location.

Referring again to the example of FIG. 9, it will be assumed, for ease of explanation, that library 104 contains a total of seven ATMs corresponding to locations 302A-302G. In practice, it may be expected that library 104 will actually contain location information about hundreds, if not thousands, of ATMs. Nonetheless, in this example, it can be seen from FIG. 9 that three of the locations—locations 302A, 302B, and 302C—fall within the area defined by search boundary 901, whereas the remaining four locations 302D, 302E, 302F, and 302G do not fall within the area defined by search boundary 901. Thus, according to the previous explanation, the subset may be determined to be those ATMs located at locations 302A, 302B, and 302C. Again, in practice, it may be expected that the subset is a small percentage of the total library 104 of ATMs. For instance, the subset may be one percent or less of all of the ATMs (and/or retail banking centers) listed in library 104.

Moreover, the subset may further exclude certain ones of the ATMs and/or retail banking centers that, while located within the bounds of search boundary 901, do not meet certain criteria. For instance, if server 103 knows the current time of day, then server 103 may exclude those ATMs and/or retail banking centers that are not currently open for business. Or, server 103 may exclude those ATMs that are currently not in service (e.g., temporarily broken). Or, server 103 may receive indications from mobile device 101 of user preferences, such as that the user is only interested in those ATMs having braille service. In that case, server 103 may only include those ATMs having braille service in the subset. Such preferences may be entered into a user interface presented by mobile device 101.

Once the subset is determined by server 103, the subset may be sent as data to mobile device 101 in step 504. The data that is sent may include the locations and any desired properties of the ATMs in the subset as stored in library 104. Mobile device 101 may then be able to use the downloaded subset to locally determine which ATMs and/or retail banking centers, if any, are proximate to mobile device 101.

To determine proximity, in step 505, mobile device 101 may first determine the size and/or shape of each of the geo-fences 303. Alternatively, the size and/or shape of each geo-fence 303 may be determined by server 103. The shape, size, and/or area of each of the geo-fences 303 may depend upon the determined speed of mobile device 101. For instance, when the speed is faster (e.g., the user of mobile device 101 is traveling by automobile), then the size (e.g., radius 903) of geo-fences 303 may be larger as compared to when the speed is slower. This may be desirable because one might expect a person traveling in an automobile to be more interested in an ATM that is five blocks away (for example) than a person who is walking The size of geo-fences 303 may also depend upon the density of ATMs. If the ATMs are numerous and close together, then a smaller set of geo-fences 303 may be more appropriate. For instance, size and/or shape of geo-fences 303 may be adjusted as needed to prevent them from overlapping. In some embodiments, all of the geo-fences 303 are the same size and/or shape. In other embodiments, the geo-fences 303 may be of differing sizes and/or shapes. Also, while circular geo-fences 303 are shown in FIG. 9, the shapes may be of any shape desired, and may be centered around or otherwise enclose the respective ATM or retail banking center.

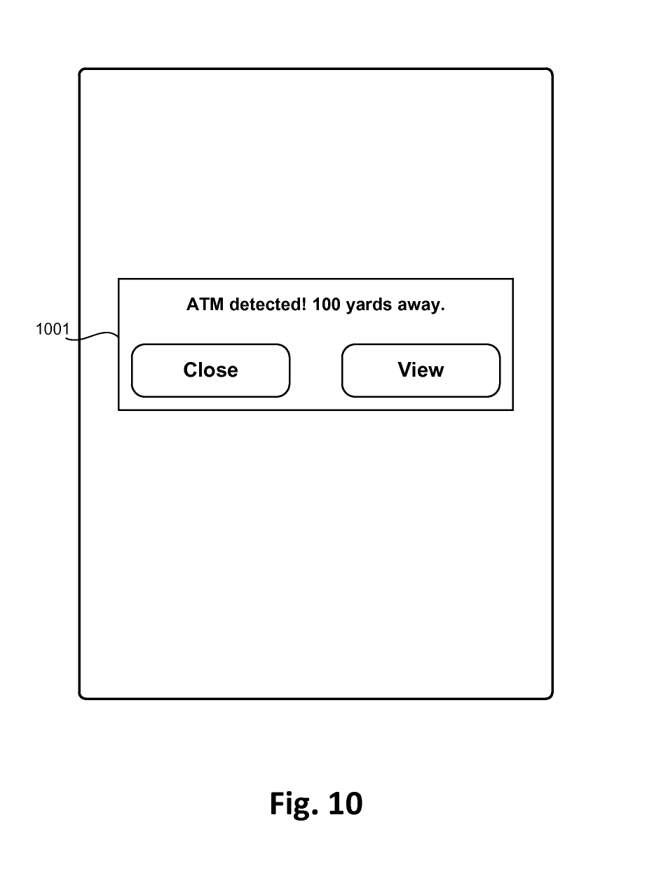

Once the geo-fences are determined, at step 506 mobile device 101 may determine whether mobile device 101 is currently within one of the geo-fences 303. If so, then at step 511, mobile device 101 may provide an alert to the user, such as via a displayed, audible, and/or tactile (e.g., vibrating) alert. FIG. 10, for instance, shows an example displayed alert 1001 stating that an ATM is detected one hundred yards away. Of course, the alert may take any form and may provide different information than in the example of FIG. 10.

If at step 506 it is determined that mobile device 101 is not currently within one of the geo-fences, then the process may move to a looped routine (steps 507-510) that begins at step 507, in which mobile device 101 may determine whether mobile device 101 has crossed into and/or is currently within one of the geo-fences 303. If so, then the loop is exited and the process moves to step 511. If not, then the process moves to step 508, in which mobile device 101 and/or server 103 may determine the current location, speed, and/or direction of the mobile device (similar to step 502). This information may be sent to server 103.

Based on the information, mobile device 101 and/or server 103 may determine, at step 509, whether the sub-library currently stored by mobile device 101 should be updated (e.g., replaced or modified). The decision may be based on one or more factors, such as whether mobile device 101 has moved to a location outside of the existing sub-library, or has moved a threshold amount of distance since the last sub-library update, or is moving at a threshold amount slower or faster than the speed at which mobile device 101 was moving when the previous sub-library was determined. For example, if a first sub-library is downloaded to mobile device 101 based on a first speed and a first location of mobile device 101, then it may be determined at step 509 that a new sub-library is needed if the current speed is at least a threshold amount higher or lower than the first speed, and/or if the current location is at least a threshold amount of distance from the first location.

If it is determined at step 509 that the sub-library should be updated, then the process may move to step 504. If it is determined at step 509 that an updated sub-library is not yet needed, then the process may move to step 510, in which mobile device 101 may determine whether the size and/or shape of geo-fences 303 need to be updated. For example, if mobile device 101 is now moving at least a threshold amount of speed faster or slower than when geo-fences 303 were previously determined, then it may be determined that the size and/or shape of geo-fences 303 should be changed. If mobile device 101 is sufficiently faster, then geo-fences 303 may be enlarged. If mobile device 101 is sufficiently slower, then geo-fences 303 may be reduced in size. If the geo-fences are decided at step 510 that they need to be updated, then the process may move to step 505 (set geo-fences). Otherwise, the process may move back to the beginning of the loop (steps 507-510) to step 507.

Thus, the sub-library that is downloaded to mobile device 101 from server 103, and/or the size and/or shape of geo-fences 303, may change dynamically over time, to reflect changes in the location, speed, and/or direction of travel of mobile device 101 over time.

As mentioned previously, if at either of steps 506 it is determined that mobile device 101 is within or has crossed one of the geo-fences 303, then the process may alert the user of such an event at step 511. Moreover, the user may be given the opportunity to view the ATM or other point of interest associated with that geo-fence 303 on a map displayed on the display of mobile device 101, or to interact with the specific location in some other manner, including but not limited to viewing branch hours or calling a certain branch's phone number. For instance, referring again to FIG. 10, the user may be able to select the “view” button to view the ATM on a map. Alternatively, the user may select the “close” button to simply close the alert. Of course, viewing on a map is merely an example of a manner in which a user may interact with the returned specific location.

Thus, in FIG. 5, step 512 may be performed to show the location on a map in response to the user selecting the “view” button (or it may be performed automatically without awaiting user input). And, if desired by the user, a navigation software application may be invoked to indicate to the user how to reach the location, such as by providing turn-by-turn directions (step 513). Once an alert is provided to the user and any maps and/or navigational assistance are provided, the process of FIG. 5 may halt until it is requested to be invoked again by the user (such as by turning on the ATM Detector function 603). Alternatively, the process may automatically move back to step 507 upon detecting that mobile device 101 has exited the geo-fence 303, so that the next crossing of a geo-fence 303 may be detected.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present disclosure. For instance, while various embodiments have been described with regard to establishing dynamic geo-fences and library subsets for ATMs and retail banking centers, these features may be implemented for any financial or non-financial point of interest, such as VTMs, retail stores, restaurants, shopping centers, gas stations, hospitals, police stations, fire stations, hotels, sports venues, red light cameras, golf courses, post offices, and pharmacies.

1. An apparatus, comprising:
a processor; and
a non-transitory computer-readable medium storing computer-executable instructions and data representing a plurality of points of interest and respective geographical locations of each of the points of interest,
wherein the processor is configured by the computer-executable instructions to perform:
receiving an indication of a location and a speed of a mobile device,
determining, based on the indicated location and speed, a subset of the plurality of points of interest, and
sending, responsive to said determining the subset, data representing the subset of the plurality of points of interest and the respective geographical locations of the subset to the mobile device.

2. The apparatus of claim 1, wherein the processor is further configured to receive an indication of a direction of travel of the mobile device, and wherein determining further comprises determining the subset of the plurality of points of interest based on the indicated location, speed, and direction of travel.

3. The apparatus of claim 1, wherein the processor is further configured to determine the subset such that the subset contains at least a predetermined minimum threshold number of points of interest.

4. The apparatus of claim 1, wherein at least some of the points of interest is each an automated teller machine (ATM) or a video teller/transaction machine (VTM).

5. A method, comprising:
determining, by a computer, a location and a speed of a mobile device;
determining, by the computer, based on the determined location and speed, a subset of a predetermined plurality of points of interest, wherein data representing the plurality of points of interest and their respective geographical locations is stored in a non-transitory computer-readable medium; and
wirelessly sending, responsive to said determining the subset, data representing the subset of the plurality of points of interest and the respective geographical locations of the subset to the mobile device.

6. The method of claim 5, further comprising determining, by the computer, a direction of travel of the mobile device, and wherein determining the subset further comprises determining the subset of the plurality of points of interest based on the determined location, speed, and direction of travel.

7. The apparatus of claim 5, wherein determining the subset further comprises determining the subset such that the subset contains at least a predetermined minimum threshold number of points of interest.

8. The method of claim 5, wherein at least some of the points of interest is each an automated teller machine (ATM) or a video teller/transaction machine (VTM).

9. A mobile device, comprising:
a processor; and
a non-transitory computer-readable medium storing computer-executable instructions and data representing a plurality of points of interest and respective geographical locations of each of the points of interest,
wherein the processor is configured by the computer-executable instructions to perform:
determining a first speed of the mobile device at a first time,
determining a plurality of geo-fences each containing one of the geographical locations, wherein a size of each of the geo-fences depends upon the determined first speed of the mobile device,
determining whether the mobile device is within one of the geo-fences, and
providing an alert to a user of the mobile device responsive to determining that the mobile device is within one of the geo-fences.

10. The mobile device of claim 9, further comprising:
determining a second speed of the mobile device at a second time, wherein the second speed is different from the first speed; and
revising the size of each of the geo-fences based upon the second speed.

11. The mobile device of claim 9, further comprising:
wirelessly sending to a network an indication of the determined first speed and a location of the mobile device;
wirelessly receiving from the network the data representing the plurality of points of interest and the respective geographical locations of each of the points of interest, wherein the plurality of points of interest depend upon the indicated first speed and the location.

12. The mobile device of claim 9, wherein at least some of the plurality of points of interest is each an automated teller machine (ATM) or a video teller/transaction machine (VTM).

13. The mobile device of claim 9, wherein determining the plurality of geo-fences comprises determining a radius of each of the geo-fences depending upon the determined first speed of the mobile device.

14. A method, comprising:
determining a subset of a plurality of points of interest and respective geographical locations of each of the subset of the points of interest;
determining, by a mobile computing device, whether the mobile computing device is located within a boundary around one of the subset of the points of interest, wherein the boundary depends upon a speed of the mobile computing device; and
displaying, by a display of the mobile computing device, a message responsive to determining that the mobile computing device is located within the boundary.

15. The method of claim 14, wherein said determining the subset comprises receiving, by the mobile computing device, data representing the subset via a wireless connection.

16. The method of claim 14, wherein each of the boundaries comprises a circle around the respective point of interest, and wherein a radius of the circle depends upon the speed of the mobile computing device.

17. The method of claim 14, wherein at least some of the points of interest is each an automated teller machine (ATM), a video teller/transaction machine (VTM), or a retail banking center.

18. The method of claim 17, wherein said determining the subset comprises determining the subset based on which of the ATMs, the VTMs, or the retail banking centers are currently available for conducting financial transactions.

19. The method of claim 17, wherein said determining the subset comprises determining the subset based on a non-location property of the ATMs, the VTMs, or the retail banking centers.

20. The method of claim 14, wherein said determining the subset further comprises determining the subset based on both the speed and a location of the mobile computing device.
